(19) United States
(12) Patent Application Publication
(10) Pub. No.: US 2026/0246206 A1
(43) Pub. Date: Aug. 20, 2026

(54) SHIELDING MEMBER AND CONNECTOR

(71) Applicant: DONGGUAN LEADER PRECISION INDUSTRY CO., LTD., Dongguan City (CN)

(72) Inventors: Zhongyuan LAI, Dongguan City (CN); Zhengguo SUN, Dongguan City (CN); Jinqi LI, Dongguan City (CN)

(73) Assignee: DONGGUAN LEADER PRECISION INDUSTRY CO., LTD., Dongguan City (CN)

(21) Appl. No.: 19/429,759

(22) Filed: Dec. 22, 2025

(30) Foreign Application Priority Data
Feb. 17, 2025 (CN) 202510174000.1

(51) Int. Cl. H01R 13/6585

(52) U.S. Cl. CPC H01R 13/6585

(57) ABSTRACT

The present application relates to a shielding member and a connector. The shielding member includes a plate portion and a tubular portion. The tubular portion is electrically connected to the plate portion, and the tubular portion is used to absorb peripheral crosstalk electromagnetic waves.

### CROSS-REFERENCE TO RELATED APPLICATION(S)

The present application claims priority of Chinese Patent Application No. 202510174000.1 filed on February 17, 2025 and entitled “Shielding Member and Connector”, which is incorporated herein by reference in its entirety.

### Field

The present application relates to the technical field of electronic communications, and in particular, to a shielding member and a connector.

### Background

On an insulating tongue core of a pluggable electrical connector, rows of signal terminals are usually arranged for signal transmission. In high-speed signal transmission, electromagnetic interference or capacitive coupling may occur between the adjacent signal terminals, leading to degradation in signal quality.

In the prior art, a partition shielding plate may be designed to isolate the interference, thereby ensuring the purity and stability of signals. However, the existing partition shielding plate is usually a single plate, and the signal terminal usually has a bent segment according to its trend. When the signal terminal is far away from the partition shielding plate due to bending (i.e., the spacing between the bent segment of the signal terminal and the straight partition shielding plate is relatively large), the shielding effect of the partition shielding plate on the signal terminal is reduced, which affects the accuracy of signal transmission in the signal terminal and limits the signal transmission capability of the connector, making the connector impossible to achieve reliable transmission of high-frequency and ultra-high-frequency signals.

### SUMMARY

An embodiment of the present application provides a shielding member, including:

a plate portion; and

a tubular portion, wherein the tubular portion is electrically connected to the plate portion, and the tubular portion is used to absorb peripheral crosstalk electromagnetic waves.

An embodiment of the present application provides a connector, including the shielding member and two rows of signal terminals, wherein the shielding member is arranged between the two rows of signal terminals.

### BRIEF DESCRIPTION OF THE DRAWINGS

FIG. 1 is a first schematic structural diagram of a shielding member according to an embodiment of the present application;

FIG. 2 is a cross-sectional view of the shielding member in FIG. 1 according to an embodiment of the present application;

FIG. 3 is an exploded view of a shielding member according to an embodiment of the present application;

FIG. 4 is a second schematic structural diagram of a shielding member according to an embodiment of the present application;

FIG. 5 is a cross-sectional view of the shielding member in FIG. 4 according to an embodiment of the present application;

FIG. 6 is a third schematic structural diagram of a shielding member according to an embodiment of the present application;

FIG. 7 is a schematic diagram of a partial structure of a shielding member according to an embodiment of the present application;

FIG. 8 is an enlarged detail view of part A in FIG. 6 according to an embodiment of the present application;

FIG. 9 is a first assembly diagram of a shielding member and signal terminals according to an embodiment of the present application;

FIG. 10 is a cross-sectional view of FIG. 9 according to an embodiment of the present application;

FIG. 11 is a second assembly diagram of a shielding member and signal terminals according to an embodiment of the present application;

FIG. 12 is a cross-sectional view of FIG. 11 according to an embodiment of the present application;

FIG. 13 is a schematic structural diagram of a connector according to an embodiment of the present application;

FIG. 14 is a schematic diagram of a partial structure of a connector according to an embodiment of the present application;

FIG. 15 is a top view of a connector according to an embodiment of the present application;

FIG. 16 is a first cross-sectional view taken along line B-B in FIG. 15 according to an embodiment of the present application; and

FIG. 17 is a second cross-sectional view taken along line B-B in FIG. 15 according to an embodiment of the present application.

### DETAILED DESCRIPTION

In order to make the objectives, technical solutions, and advantages of the embodiments of the present application clearer, the technical solutions in the embodiments of the present application will be described clearly and completely below in conjunction with the accompanying drawings therein. Apparently, the described embodiments are some of the embodiments of the present application, not all of them. Based on the embodiments of the present application, all other embodiments obtained by those of ordinary skill in the art without any creative effort shall fall within the scope of protection of the present application.

The following disclosure provides many different embodiments or examples to implement different structures of the present application. In order to simplify the disclosure of the present application, components and settings in specific examples are described below. Such components and settings are merely examples and are not intended to limit the scope of the present application. In addition, the present application may repeat reference numerals and/or letters in different examples. The repetition is for the purpose of simplification and clarity, and does not indicate the relationship between various discussed embodiments and/or settings.

For ease of description, spatial relative relationship terms can be used herein to describe the relative position or motion of one element or feature shown in the figures relative to the other element or feature. These relative relationship terms include "internal", "external", "inner", "outer", "below", "under", "on", "above", "front", "rear", etc. The spatial relative relationship terms are intended to include different orientations of an apparatus in use or operation, in addition to the orientations depicted in the figures. For example, if the apparatus in the figures undergoes a position flip, posture change, or motion state change, these directional indications also change accordingly. For example, one element described as "below the other element or feature" or "under the other element or feature" will subsequently be oriented as "on the other element or feature" or "above the other element or feature". Therefore, the exemplary term "under" may include both upper and lower orientations. The apparatus can be oriented otherwise (rotated 90 degrees or in other directions) and the spatial relative relationship descriptors used herein are explained accordingly.

In order to solve the technical problem of limited signal transmission capabilities of connectors due to the fact that straight partition shielding plates in the prior art cannot achieve an efficient shielding effect, an embodiment of the present application provides a shielding member 1 and a connector 100, wherein the shielding member 1 includes a plate portion 11 and a tubular portion 12, and the distance between the shielding member 1 and a signal terminal 3 can be shortened through the tubular portion 12, whereby the shielding effect of the shielding member 1 on electromagnetic fields can be enhanced, and crosstalk electromagnetic waves of the signal terminal 3 can be efficiently absorbed, thereby improving shielding efficiency. Such design helps to reduce the impact of external electromagnetic fields on signal transmission, and ensures the accuracy and stability of signals, thereby enhancing the high-frequency signal transmission capability of the connector.

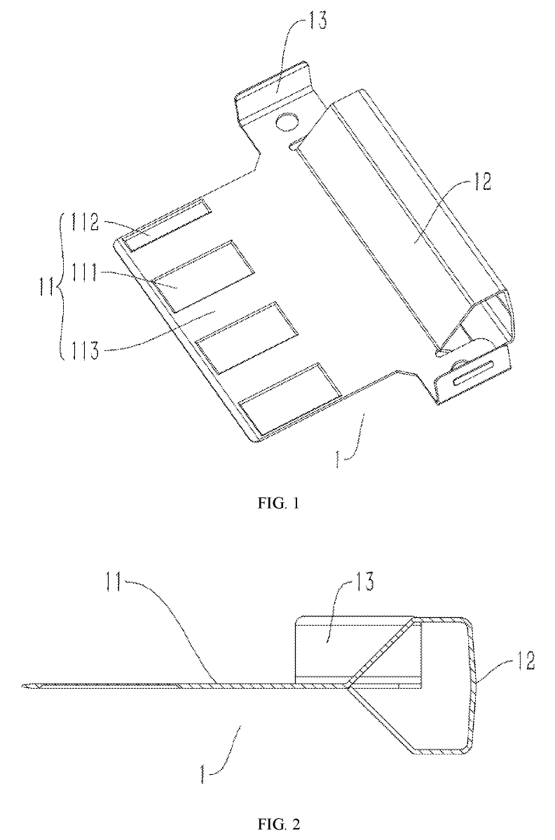

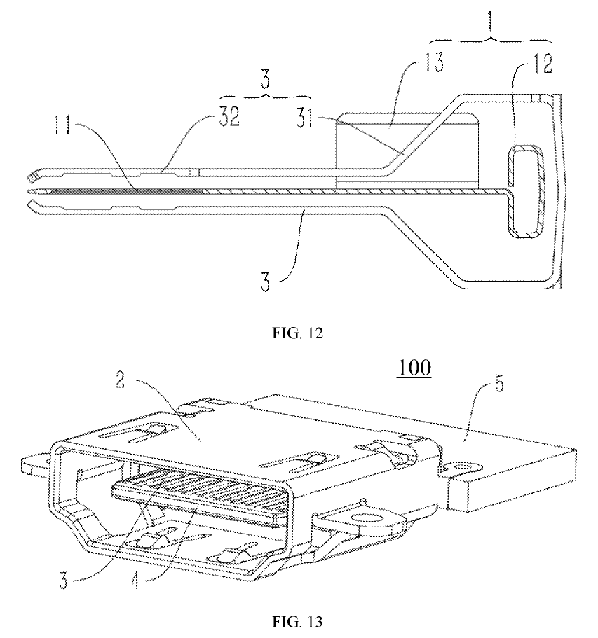

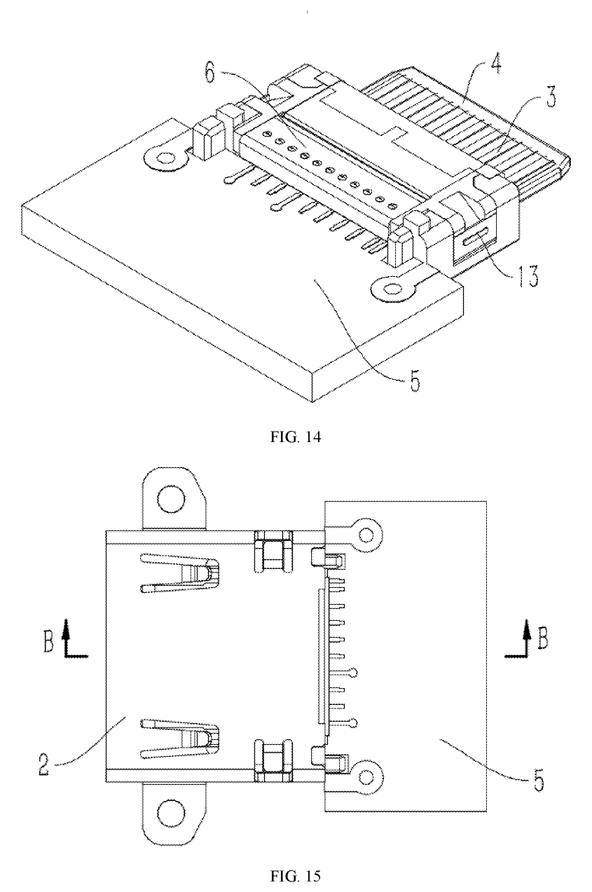

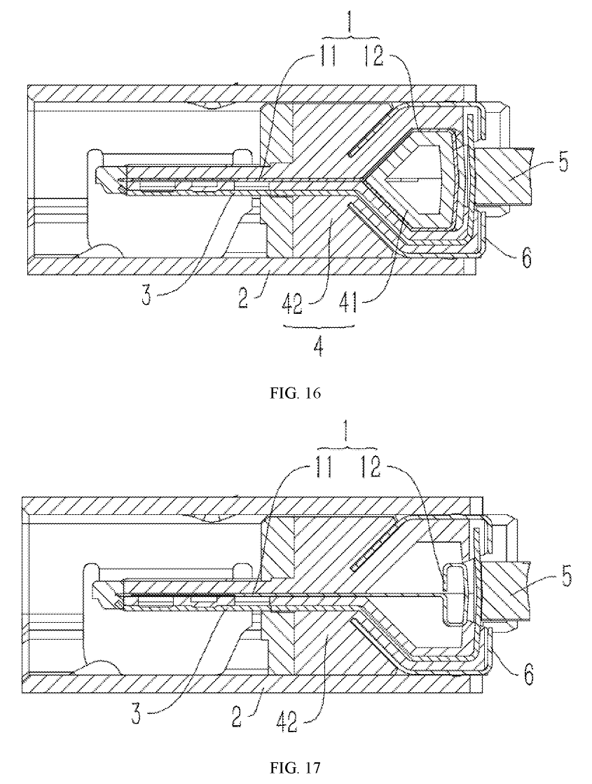

With reference to FIG. 1 to FIG. 17, a first aspect of embodiments of the present application provides a shielding member 1, including a plate portion 11 and a tubular portion 12, wherein the tubular portion 12 is electrically connected to the plate portion 11, so as to transmit crosstalk electromagnetic waves absorbed by the plate portion 11 and the tubular portion 12 to a grounding circuit through other components (such as a metal shell 2), as shown in FIG. 1 to FIG. 8.

The tubular portion 12 is used to absorb peripheral crosstalk electromagnetic waves, especially crosstalk electromagnetic waves around a signal terminal 3 with a bent segment 31. In a thickness direction of the plate portion 11, since the thickness of the tubular portion 12 is greater than that of the plate portion 11, the distance between the shielding member 1 and the bent segment 31 of the signal terminal 3 can be shortened through the tubular portion 12, as shown in FIG. 9 to FIG. 12. The shortened distance between the shielding member 1 and the signal terminal 3 can enhance the shielding effect of the shielding member 1 on electromagnetic fields, thereby improving the overall shielding effectiveness of the shielding member 1.

It should be noted that the shielding member 1 is made of metal. When the distance between the shielding member 1 and the signal terminal 3 is shortened, the electromagnetic coupling effect between them will be enhanced. This means that signals are less likely to leak out of a gap between the shielding member 1 and the terminal, thereby reducing the interference of external electromagnetic fields on the signal terminal 3.

By shortening the distance between the shielding member 1 and the signal terminal 3 through the tubular portion 12, the shielding effect can be improved without space addition, thereby optimizing space utilization and lowering manufacturing costs.

It should be noted that the position of the tubular portion 12 on the shielding member 1 may be determined based on the distribution of the bent segment 31 of the signal terminal 3, thereby avoiding contact and interference between the tubular portion 12 and the signal terminal 3.

Since the bent segment 31 of the signal terminal 3 is usually designed at a tail end, the tubular portion 12 is preferably arranged at one end of the plate portion 11, and an axis of the tubular portion 12 is parallel to a width direction of the plate portion 11. A peripheral side wall of the tubular portion 12 is used to shorten the distance between the tail end of the shielding member 1 and the bent segment 31 at the tail end of the signal terminal 3, thereby enhancing the shielding effect of the shielding member 1 on crosstalk electromagnetic waves, as shown in FIG. 9 to FIG. 12.

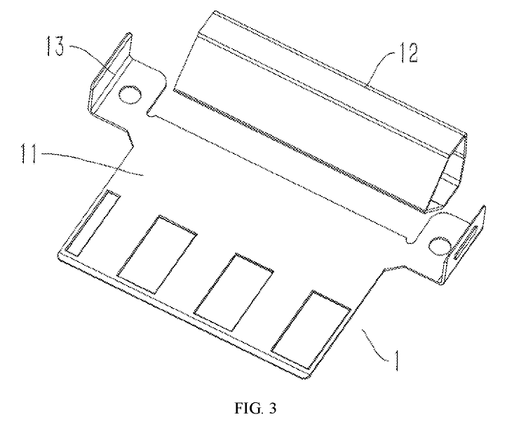

In some embodiments of the present application, as shown in FIG. 1 and FIG. 3, the tubular portion 12 is arranged at one end of the plate portion 11, and the plate portion 11 is separated from the tubular portion 12, so that the plate portion 11 and the tubular portion 12 can be manufactured separately. Then, different models of plate portions 11 and different shapes of tubular portions 12 are assembled to obtain shielding members 1 in different structural forms, achieving matching of the shielding members 1 with signal terminals 3 in various shapes.

In other embodiments of the present application, as shown in FIGS. 1, 2, 4, and 5, the tubular portion 12 is arranged at one end of the plate portion 11, and the plate portion 11 is integrated with the tubular portion 12, wherein the tubular portion 12 may be made by bending the tail end of a metal plate repeatedly, which is beneficial to reducing the difficulty in manufacturing the shielding member 1 and improving the reliability of connection between the plate portion 11 and the tubular portion 12.

In some embodiments of the present application, as shown in FIG. 1 to FIG. 8, the cross-sectional shape of the tubular portion 12 is polygonal, circular, or elliptical. The cross-sectional shape and size of the tubular portion 12 may be designed according to impedance matching requirements. As long as the cross-sectional shape and size enable absorption of crosstalk electromagnetic waves between signal terminals 3 (inside the space between upper and lower rows of signal terminals 3), the objective of the present application can be achieved.

It should be noted that when the cross-sectional shape of the tubular portion 12 is polygonal (i.e., with 3 or more edges), the polygon may be a regular polygon or a non-regular polygon. As long as the cross-sectional shape can maintain a suitable distance between the outer wall of the tubular portion 12 and the signal terminal 3, the objective of the present application can be achieved.

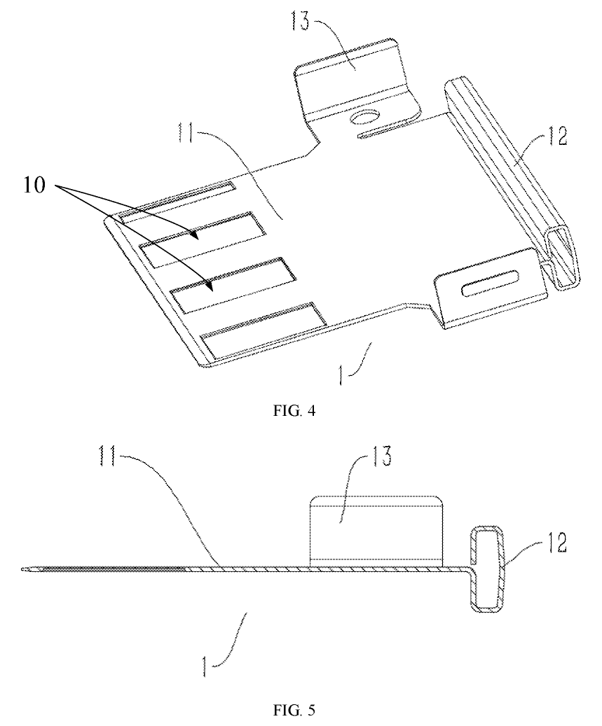

In some embodiments of the present application, as shown in FIG. 2 and FIG. 4, the cross-section of the tubular portion 12 is axisymmetric, and the axis of symmetry of the cross-section is parallel to a length direction of the plate portion 11 (the left-right direction in FIG. 2 is the length direction), enabling the tubular portion 12 to extend towards both sides of the plate portion 11 in a thickness direction by an equal distance, thereby forming a structurally symmetrical partition shielding member 1. By evenly distributing a shielding material, the influence of external electromagnetic interference on internal signals can be reduced more effectively, and the overall shielding efficiency can be improved, thereby ensuring the stability and quality of signals.

In some embodiments of the present application, as shown in FIGS. 1, 2, 9, and 10, the cross-section of the tubular portion 12 is pentagonal, there is a first preset distance L1 between the tubular portion 12 and the bent segments 31 of the upper row of signal terminals 3, and there is a second preset distance L2 between the tubular portion 12 and the bent segments 31 of the lower row of signal terminals 3. Such design shortens the distances between the metal plate of the tubular portion 12 and the bent segments 31 of the upper and lower rows of signal terminals 3, thereby improving the absorption effect of the tail end of the shielding member 1 on crosstalk electromagnetic waves inside the space between the upper and lower rows of signal terminals 3.

In other embodiments of the present application, as shown in FIGS. 4, 5, 11, and 12, the cross-section of the tubular portion 12 is rectangular. Such design can also shorten the distances between the metal plate of the tubular portion 12 and the bent segments 31 of the upper and lower rows of signal terminals 3, thereby improving the absorption effect of the tail end of the shielding member 1 on crosstalk electromagnetic waves inside the space between the upper and lower rows of signal terminals 3.

In some preferred embodiments of the present application, as shown in FIGS. 1, 9, and 10, the cross-sectional shape of the tubular portion 12 is matched with the shape of the signal terminals 3 outside, that is, the cross-sectional shape of the tubular portion 12 is the same as the cross-sectional shape of a space enclosed by the bent segments 31 of the upper and lower rows of signal terminals 3, and the two cross-sections are concentric (i.e., centers of the cross-sections coincide). At different positions in the circumferential direction of the space, the distance between the outer wall of the tubular portion 12 and the plate body of the opposite bent segment 31 may be identical or approximately identical. The balanced absorption of crosstalk electromagnetic waves at various positions in the circumferential direction of the bent segment 31 through the tubular portion 12 is beneficial to improving the shielding effect of the tubular portion 12 on the space.

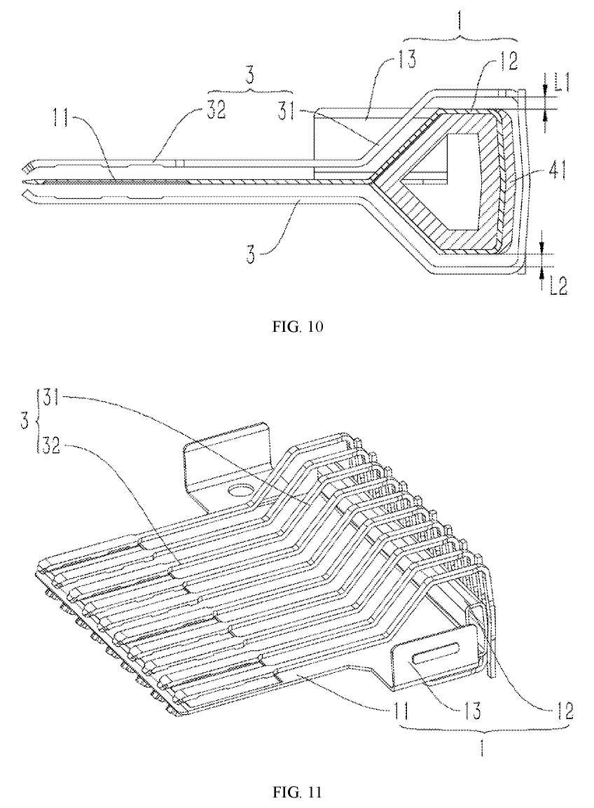

As a specific embodiment of the present application, as shown in FIG. 9 and FIG. 10, the signal terminal 3 includes a straight segment 32 and a bent segment 31, the upper and lower rows of bent segments 31 enclose a pentagonal space, the tubular portion 12 is arranged inside the space, and the cross-sectional shape of the tubular portion 12 is the same as that of the space. Such design can absorb the crosstalk electromagnetic waves inside the space, thereby ensuring fast, smooth, and balanced signal transmission.

In some embodiments of the present application, as shown in FIGS. 1, 4, 6, and 7, the plate portion 11 is provided with one or more grooves 10, which can change the electromagnetic field distribution of the plate portion 11, thereby more effectively limiting and reducing the propagation range of electromagnetic waves, confining electromagnetic wave signals within a specific area, reducing electromagnetic interference, and protecting the signal terminals 3 inside the connector from external electromagnetic signals.

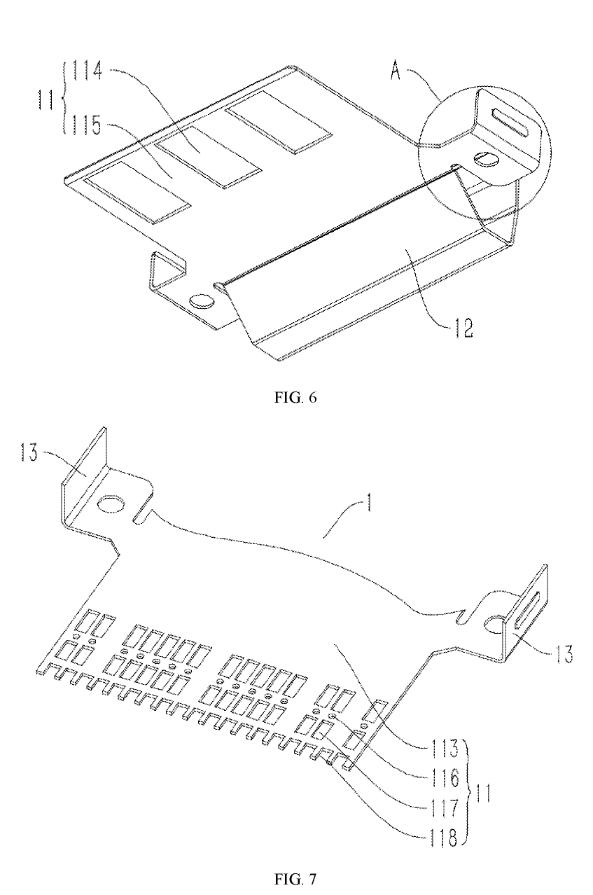

In some embodiments of the present application, as shown in FIG. 1 and FIG. 6, the groove is recessed on one plate surface or two plate surfaces of the plate portion 11. Since the groove does not penetrate the plate portion 11, the same or different electromagnetic field distributions may be formed on the two plate surfaces of the plate portion 11 to provide stronger electromagnetic shielding effect in a specific area, thereby reducing electromagnetic interference in that area.

As a specific embodiment of the present application, as shown in FIG. 1 and FIG. 6, a plurality of first grooves 111 and second grooves 112 are provided on a first plate surface 113 of the plate portion 11, and the first grooves 111 and second grooves 112 are arranged at a front end of the plate portion 11 to avoid interference of external electromagnetic signals with the front end of the upper row of signal terminals 3. A plurality of third grooves 114 are provided on a second plate surface 115 of the plate portion 11 to avoid interference of external electromagnetic signals with the front end of the lower row of signal terminals 3.

It should be noted that when the grooves do not penetrate the plate portion 11, a denser shielding layer will be formed locally. The shielding layer provides a stronger electromagnetic shielding effect in a specific area, will not excessively damage the overall structure of the shielding member 1, maintains the mechanical strength and stability of the plate portion 11, and enables the tubular portion to better withstand external pressure and vibration in an insertion process.

In other embodiments of the present application, as shown in FIG. 7, the grooves penetrate the plate portion 11. Such design can change the propagation path of electromagnetic waves, and make it more difficult for the electromagnetic waves to penetrate the shielding member 1, thereby further reducing the propagation of electromagnetic interference and improving the electromagnetic compatibility of the connector.

It should be noted that the shape, size, and position of the grooves may be designed according to the adjustment requirements of electromagnetic waveforms to achieve desired technical effects.

As a specific embodiment of the present application, as shown in FIG. 7, the plate portion 11 has a plurality of fourth grooves 116, fifth grooves 117, and sixth grooves 118 designed in a penetrating manner. Such design reduces the propagation of electromagnetic interference. The plurality of fourth grooves 116, fifth grooves 117, and sixth grooves 118 may serve as heat dissipation channels of the plate portion 11 to dissipate heat inside the shielding member 1, facilitating high-frequency and high-speed data transmission.

Specifically, the fourth grooves 116 are circular through grooves, which can effectively reduce high-frequency electromagnetic interference. The structural symmetry of the circular through grooves facilitates uniform distribution of electromagnetic fields, and reduces signal reflection and crosstalk. The fifth grooves 117 are rectangular through grooves, which can provide a better shielding effect in a specific direction and are particularly suitable for scenarios that require directional shielding. The sixth grooves 118 are U-shaped grooves with front openings, which provide a good shielding effect and reduce signal reflection and crosstalk, especially in complex electromagnetic environments. By combining grooves of various shapes, different electromagnetic shielding effects can be formed in different areas of the plate portion 11, thereby optimizing the signal transmission performance and shielding effect of the connector.

In some embodiments of the present application, as shown in FIG. 1 to FIG. 8, the shielding member 1 further includes a connecting portion 13, wherein the connecting portion 13 is connected to the plate portion 11, used for electrical connection with the metal shell 2 of the connector, and connected to a circuit board 5 through the metal shell 2 to form a grounding circuit, enabling the potential of the metal shell 2 to be the same as that of the shielding member 1 and preventing the metal shell 2 from introducing external electromagnetic interference into the signal terminal 3.

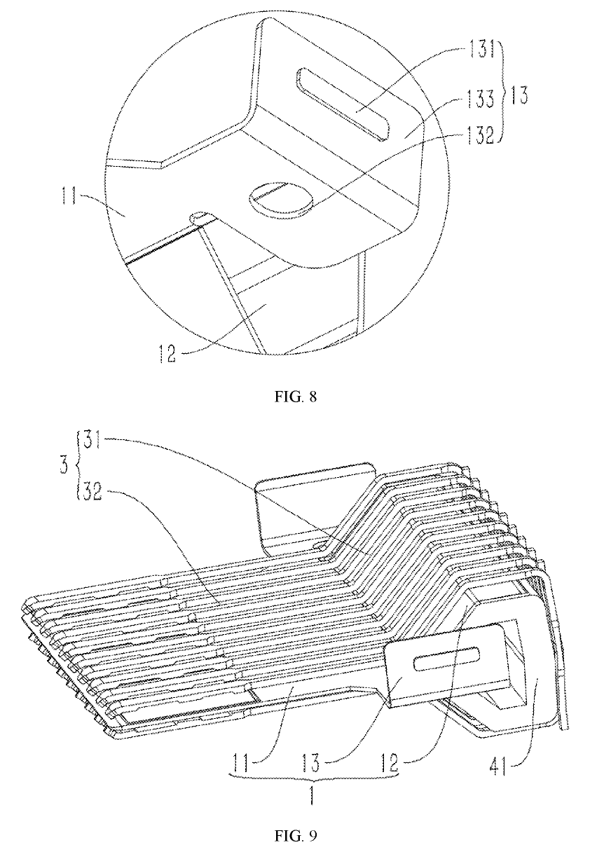

In some embodiments of the present application, as shown in FIG. 6 and FIG. 8, the connecting portion 13 is arranged on both sides of the plate portion 11, and the connecting portion 13 is provided with a protruding structure 131 away from the plate portion 11. When the metal shell 2 is clamped to the outer side of an insulating tongue core of the connector, the protruding structures 131 exposed to an insulating body 4 can directly abut against the inner walls of both sides of the metal shell 2, thereby achieving electrical connection between the shielding member 1 and the metal shell 2, and improving the reliability and convenience of connection between the connecting portion 13 and the metal shell 2.

As a specific embodiment of the present application, as shown in FIG. 6 and FIG. 8, two connecting portions 13 are symmetrically arranged on left and right sides of the shielding member 1, and can be used to abut against the inner walls of left and right sides of the metal shell 2 to achieve ground transmission of electromagnetic waves, thereby blocking external electromagnetic interference from entering the signal transmission system, protecting signals inside the system from external noise interference, and improving the accuracy and stability of signal transmission.

In some embodiments of the present application, as shown in FIG. 8, the protruding structure 131 has an abutting surface, and the abutting surface is used for contacting the inner wall of the metal shell 2, wherein the abutting surface can increase the contact area between the protruding structure 131 and the metal shell 2, decrease the contact resistance between the protruding structure 131 and the metal shell 2, and allow smoother transmission of electromagnetic waves at the connection.

In some embodiments of the present application, as shown in FIG. 8, the connecting portion 13 further includes an ear plate 133, and the protruding structure 131 protrudes from an outer surface of the ear plate 133. The connecting portion 13 and the plate portion 11 are of a one-piece connection structure. The connecting portion 13 may be made by bending two sides of a metal plate body, which is conducive to reducing the difficulty in producing the shielding member 1 and improving the reliability of connection between the plate portion 11 and the connecting portion 13.

It should be noted that the ear plate 133 is made of metal, with certain deformation capability. When the protruding structure 131 is subjected to an abutting force from the inner wall of the metal shell 2, the ear plate 133 will be deformed under an external force and produce a deformation elastic force, which enables the protruding structure 131 to tightly abut against the inner wall of the metal shell 2, thereby improving the tightness and reliability of connection between the protruding structure 131 and the metal shell 2.

In some embodiments of the present application, as shown in FIG. 8, the ear plate 133 is further provided with a positioning structure 132, which facilitates positioning assembly between the shielding member 1 and the insulating body 4. The positioning structure 132 may specifically be a positioning groove, a positioning protrusion, etc., all of which can achieve the objective of the present application.

As shown in FIG. 1 to FIG. 17, a second aspect of the embodiments of the present application provides a connector 100, including the shielding member 1 described in the foregoing embodiments, a metal shell 2, and two rows of signal terminals 3, wherein the shielding member 1 is arranged between the two rows of signal terminals 3, as shown in FIGS. 9, 10, 11, 12, 16, and 17. The shielding member 1 can shield crosstalk electromagnetic waves between the upper and lower rows of signal terminals 3 and absorb crosstalk electromagnetic waves inside the space, thereby ensuring fast, smooth, and balanced signal transmission.

The shielding member 1 is electrically connected to the metal shell 2, and then the metal shell 2 is connected to a circuit board 5 to form a grounding circuit, thereby enabling the potential of the metal shell 2 to be the same as that of the shielding member 1, preventing the metal shell 2 from introducing external electromagnetic interference into the signal terminals 3, avoiding damage to the integrity of signal transmission of the connector, reducing data loss, and reducing bit error rates.

In some embodiments of the present application, as shown in FIGS. 13, 14, 15, 16, and 17, shielding plates 6 are further provided outside the signal terminals 3. The two shielding plates 6 are arranged on two outer sides of the tail ends of the two rows of signal terminals 3 respectively, and are used for electrical connection with the metal shell 2 of the connector, thereby enabling the potential of the shielding plates 6 to be the same as that of the metal shell 2, shielding the crosstalk electromagnetic waves inside the space, and further improving the signal transmission effect of the connector.

On the basis that the shielding member 1 absorbs internal crosstalk electromagnetic waves between the upper and lower rows of signal terminals 3, the two shielding plates 6 arranged on the two outer sides of the tail ends of the signal terminals 3 further shield external crosstalk electromagnetic waves, thereby ensuring fast, smooth and balanced signal transmission of the connector.

In some embodiments of the present application, as shown in FIGS. 15, 16, and 17, in order to fix the shielding member 1 and the signal terminals 3 in the connector, the shielding member 1 and the plurality of signal terminals 3 are all embedded in an insulating body 4. The plate portion 11 and the straight segments 32 and the signal terminals 3 are embedded in an insulating tongue plate at a front end of the insulating body 4, and the tubular portion 12 and the bent segments 31 of the signal terminals 3 are embedded in an insulating block 42 at a tail end of the insulating body 4, achieving the assembly and arrangement of the shielding member 1 and the signal terminals 3 inside the connector.

It should be noted that the tubular portion 12 may alternatively be embedded in an insulating tube 41 of the insulating body 4 to avoid electrical connection between the signal terminals 3 and the shielding member 1, thereby preventing current from flowing through undesired paths and thus avoiding the problems of short circuits, signal interference, etc. Such design can also ensure that signal terminals 3 are not interfered by the shielding member 1 during signal transmission, maintains the integrity and accuracy of signals, and is particularly important for high-frequency and high-speed signal transmission.

According to the connector of the present application, the shielding member 1 abuts against the inner wall of the metal shell 2, thereby achieving ground transmission of crosstalk electromagnetic waves, blocking external electromagnetic interference from entering the signal transmission system, protecting signals inside the system from external noise interference, improving the accuracy and stability of signal transmission, and making the connector of the present application more suitable for high-precision, high-reliability, and high-frequency transmission application scenarios.

It should be understood that the terms used herein are only for the purpose of describing specific exemplary implementations and are not intended to be restrictive. Unless otherwise explicitly stated in the context, singular forms such as "a", "one", and "the" used herein may further include plural forms. The terms "comprise", "include", "contain", and "have" are inclusive and therefore indicate the existence of the stated features, steps, operations, elements, and/or components, but do not exclude the existence or addition of one or more other features, steps, operations, elements, components, and/or combinations thereof. The method steps, processes, and operations described herein are not interpreted as requiring them to be executed in a specific order described or illustrated, unless an execution order is clearly indicated. It should also be understood that additional or alternative steps can be used.

Although the terms first, second, third, etc. can be used herein to describe a plurality of elements, components, regions, layers, and/or segments, these elements, components, regions, layers, and/or segments should not be limited by these terms. These terms can only be used for distinguishing one element, component, region, layer, or segment from another. Unless explicitly stated in the context, the terms such as "first" and "second" and other numerical terms used herein do not imply order or sequence. Therefore, the first element, component, region, layer, or segment discussed below may be referred to as the second element, component, region, layer, or segment without departing from the teachings of the example embodiments.

Described above are merely specific implementations of the present application, enabling a person skilled in the art to understand or implement the present application. Various modifications to these embodiments are apparent to the person skilled in the art. General principles defined herein may be implemented in other embodiments without departing from the spirit or scope of the present application. Therefore, the present application will not be limited to these embodiments shown herein, but will conform to the widest scope consistent with the principle and novelty of the present application.

What is claimed is:

1. A shielding member, comprising:
a plate portion; and
a tubular portion, wherein the tubular portion is electrically connected to the plate portion, and the tubular portion is used to absorb peripheral crosstalk electromagnetic waves.

2. The shielding member according to claim 1, wherein the tubular portion is arranged at one end of the plate portion, and the plate portion is separated from the tubular portion;
or the tubular portion is arranged at one end of the plate portion, and the plate portion is integrated with the tubular portion.

3. The shielding member according to claim 1, wherein the cross-sectional shape of the tubular portion is polygonal, circular, or elliptical.

4. The shielding member according to claim 1, wherein the cross-section of the tubular portion is axisymmetric, and the axis of symmetry of the cross-section is parallel to a length direction of the plate portion.

5. The shielding member according to claim 1, wherein the cross-sectional shape of the tubular portion is matched with the shape of signal terminals outside.

6. The shielding member according to claim 1, wherein the plate portion is provided with one or more grooves.

7. The shielding member according to claim 6, wherein the grooves are recessed on one plate surface or two plate surfaces of the plate portion.

8. The shielding member according to claim 6, wherein the grooves penetrate the plate portion.

9. The shielding member according to claim 1, wherein the shielding member further comprises a connecting portion, wherein the connecting portion is connected to the plate portion and used for electrical connection with a metal shell of a connector.

10. The shielding member according to claim 9, wherein the connecting portion is arranged on both sides of the plate portion, and the connecting portion is provided with a protruding structure away from the plate portion.

11. The shielding member according to claim 10, wherein the protruding structure has an abutting surface, and the abutting surface is used for contacting an inner wall of the metal shell.

12. A connector, comprising the shielding member according to claim 1, and two rows of signal terminals, wherein the shielding member is arranged between the two rows of signal terminals.

13. The connector according to claim 12, wherein the tubular portion is arranged at one end of the plate portion, and the plate portion is separated from the tubular portion;
or the tubular portion is arranged at one end of the plate portion, and the plate portion is integrated with the tubular portion.

14. The connector according to claim 12, wherein the cross-sectional shape of the tubular portion is polygonal, circular, or elliptical.

15. The connector according to claim 12, wherein the cross-section of the tubular portion is axisymmetric, and the axis of symmetry of the cross-section is parallel to a length direction of the plate portion.

16. The connector according to claim 12, wherein the cross-sectional shape of the tubular portion is matched with the shape of the signal terminals outside.

17. The connector according to claim 12, wherein the plate portion is provided with one or more grooves.

18. The connector according to claim 17, wherein the grooves are recessed on one plate surface or two plate surfaces of the plate portion.

19. The connector according to claim 17, wherein the grooves penetrate the plate portion.

20. The connector according to claim 12, wherein the shielding member further comprises a connecting portion, wherein the connecting portion is connected to the plate portion and used for electrical connection with a metal shell of the connector.
